(19) United States
(12) Patent Application Publication
(10) Pub. No.: US 2003/0176527 A1
(43) Pub. Date: Sep. 18, 2003

(54) Coating agents which can be hardened by means of uv radiation, method for producing coatings from said coating agents and use thereof

(76) Inventors: Dietmar Votteler, Kallenbergstrasse 81 (DE); Siegfried Fabriz, Pleidelsheim (DE); Jorg Sentko, Hemmingen (DE)

Correspondence Address: Stephan A Pendorf, Pendorf & Cutliff, P O Box 20445, Tampa, FL, 33622-0445, US

(21) Appl. No.: 10/297,140

(22) PCT Filed: May 26, 2001
(86) PCT No.: PCT/EP01/06037

(30) Foreign Application Priority Data
Jun. 3, 2000 (DE) 10027670.9

(51) Int. Cl. C08J 3/28

(52) U.S. Cl. 522/113

(57) ABSTRACT

The invention relates to acrylate-based coating compositions which can be hardened by means of UV radiation, and used to coat wood components. This coating composition contains 5 to 80 weight % of acrylic resin, 5 to 75 weight % of a reactive diluent agent, 0.1 to 5 weight % of a thixotropic agent, 0.1 to 10 weight % of a photo-initiator and 0.05 to 20 weight % of an additive. The invention also relates to the method for producing coatings, wherein 4 to 8 layers are hot-sprayed onto pre-fabricated wooden elements and hardened by means of UV radiation. The invention is characterized in that the coated components have low emissions after the final hardening and have VOC values (volatile organic compounds) of <100 ppm. These values are far below the standard values of known polyester lacquers.

### BACKGROUND OF THE INVENTION

1. Field of the Invention

The invention concerns a coating material which is hardenable by UV-radiation, process for production of coatings from this coating material and various applications thereof.

2. Description of the Related Art

Until now, for coating flat surfaces such as wood pieces, sheets, strips or the like, or for coating three dimensional articles such as for example kitchen furniture, peroxide hardenable polyester coatings, for example paraffin containing coatings based on phallic acid anhydride, or paraffin free coatings with glossy surfaces based on allylether have been employed. The layers were applied by conventional coating application processes such as roller coating, pouring or spraying.

Further, for the coating of wood components, as intended for the interior of automobiles, there have until now been employed peroxide hardenable polyester coatings on the basis of unsaturated polyester, diluted with styrol or with compounds with a vinyl functionality. The viscosities of these polyester coatings were adjusted to a viscosity in the range of approximately 150 to 250 mPa.s at 21° C. so that they could be sprayed. These polyester coatings could be applied using compressed air sprayers, wherein polyester and peroxide components are mixed in the preliminary mixing process and are sprayed from a single pot. It is also possible, in a two component spray process, to separately introduce the peroxide component and polyester component to the spray gun and there to mix these in the spray nozzle. The wood components are prepared for the spray coating by staining, priming, and in certain cases painting and insulating. Following drying, the polyester coating layer is sprayed onto the thus prepared substrate.

Conventionally multiple layers, for example 4 to 8 layers, were applied one upon the other, each with a thickness of approximately 150 to 240 μm, so that final layer thicknesses were obtained which would make possible a subsequent processing of the combined layer, for example by grinding and polishing. It is necessary that the applied polyester coatings are thixotropic, so that they remain in place even on vertical surfaces. For adjusting the thixotripism they are provided with inorganic and/or organic thixotropic agents. The individual layers are intermediate-set and intermediate-hardened by UV-radiation. The intermediate setting and intermediate hardening occurs by the radicals released from the peroxide component upon UV-radiation and takes, depending upon the setting of the radiation, for each individual layer, approximately 10 to 30 minutes. The final hardening of the total layer occurs by a supplemental radiation with a high pressure or medium pressure mercury vapor lamp.

After radiation, the parts must be stored three to four days in order to achieve the necessary final hardness for the final processing. During hardening a loss in volume of approximately 12 to 17% occurs. A loss in weight occurs in approximately the same order of magnitude. The thereby lost components, which are given off into the atmosphere, are comprised in polyester/styrol systems primarily of styrene monomers or of styrene oxide, which is produced during the polymerization of styrene monomers. Both substances are vaporizing organic compounds, or “volatile organic compounds” (VOC), which are undesirable in the sense of VOC-regulations. Likewise undesired is cyclohexanone, which results from the cyclohexanone peroxide employed for polymerization.

Depending upon the type of polymerization, the polyester layer contains more or less volatile components, which likewise are eventually given off. These include, besides the above mentioned substances, phthalates and solvent residues. The VOC-value, which is the measure of the volatile components, for the above-mentioned coating systems lies in the range of approximately 1,500 ppm, and for paraffin containing polyester coatings, at approximately 1,700 to 2,200 ppm.

Environmental requirements necessitate in the future a VOC-value of less than 100 ppm, which is not achievable with polyester coatings.

Accordingly, a different coating system must be developed, which can satisfy these requirements. As such, one could consider a UV-hardenable acrylate coating system. Until now radiation hardenable acrylate coatings have been applied using conventional coating application processes, for example by thin layer application using rollers, wherein the layer thickness of the applied layers lies at 5 to 15 μm. These thin layers are also applied in multiple layers, intermediate hardened and partially even intermediate-ground. The intermediate hardening, which is necessary for the adhesion of the subsequent layer, is achieved using UV-radiation. By thin layer application by rollers one employs a viscosity of approximately 300 to 800 mPa.

For coating application processes by spraying one requires a lower viscosity in the range of approximately 150 to 250 mPa.s at 21° C. For spraying, one has employed acrylate with supplemental solvents, in order to achieve a desired flowability, in order to keep the layer thickness as low as possible, to obtain bubble-free layers and, if desired, to subsequently adjust a matting. In the processing of radiation hardenable coatings by spraying, until now solvents have been selected which are less hazardous to health. Reactive diluents, which in this respect are substantially more problematic, have as a rule not been employed.

### SUMMARY OF THE INVENTION

Beginning therewith, it is the task of the present invention to develop a flowable UV-light hardenable coating agent, which has a good sprayability, good film forming characteristics with respect to the end product and exhibits a low VOC-value.

The task is inventively solved by a flowable UV-hardenable coating material comprised of the following components:

5-80 weight % of a mixture of monomers, oligomers and multifunctional polymers of cross-linkable acrylates and/or methacrylates;

5-75 weight % of a reactive diluent;

0.1-5 weight % of a thixotropic agent;

0.1-10 weight % of a photo initiator and

0.05-20 weight % additive.

Advantageous embodiments of the invention can be seen from dependent claims 2-11.

The invention further concerns a process for producing a coating on a pre-treated or pre-assembled wood surface, in which the coating agent is applied by hot spraying at 35 to 80° C. in multiple layers with a layer thickness of 50 to 800 μm and each layer is intermediate hardened by UV-radiation.

With these inventive measures it is achieved, that the coated, hardened wood component is machineable, grindable, polishable and light resistant, chemical resistant and moisture resistant. Regarding moisture resistance, the ability to withstand 500 hours of exposure to condensing water (at 40° C. and 95% relative humidity) is required. The most important characteristic is that the inventive coating material is low in emissions, that is, has a low VOC-value of less than 100 ppm.

### DETAILED DESCRIPTION OF THE INVENTION

In the following the invention will be described in greater detail on the basis of a description of a preferred embodiment.

The invention concerns UV-light hardenable coating compositions which utilize acrylic resin as the coating starting material. The significance of the invention is particularly to be seen therein, that solvent-free and emission poor coatings are employed which result in a number of desired characteristics.

The coating agent contains approximately 5 to 80 weight %, preferably 10 to 60 weight %, multi-functional cross-linkable acrylate or, as the case may be, methacrylate. Starting materials are, depending upon structure, polyether-, polyester-, polyepoxy-, urethane-, melamin-, and silicon-acrylate and/or methacrylate and acrylated and/or methacrylated polyacrylate. Preferred in accordance with the invention is an epoxy acrylate in an amount of 50 to 80 parts by weight of which a diglycidylether of Bisphenol A is reacted with two molar equivalents of acrylic acid. The materials include all molecular weight ranges between monomers, oligomers and polymers and include in certain cases besides the acrylate groups also further functional groups. The molecular weight (as average weight) lies in a range of approximately 500 to 6,000, wherein the composition is so selected, that an application by spraying is made possible and significant low molecular components are present, so that a total viscosity of 150 to 250 mPa at 21° C. results. In order that good film forming characteristics of the end product are achieved, it is necessary on the other hand that high molecular components are present.

The coating contains approximately 5 to 75 weight % of a reactive diluent. The reactive diluents may be monomers or on the other hand low viscosity oligomers, which replace the volatile organic solvents. They have molecular weights in the range of approximately 50 to 500. The reactive diluents, which contain radical polymerizable residues, are selected from the group of acrylic esters of simple alcohols, hexane diol-diacrylate, hydroxy methyl ethyl acrylate, hydroxy propyl acrylate, polyethylene glycol diacrylate, tri-methyl propane tri-acrylate, diproplyene glycol diacrylate, tri-propylene glycol diacrylate or mixtures thereof and polyester acrylates. Styrene free unsaturated acrylate and polyester acrylic resins are obtainable for example under the commercial names Laromer® and Sartomer® from BASF.

For adjustment of the thixotropism of the coating layer approximately 0.1 to 30 weight % of a thixotrophic agent on the basis of silicone dioxide is added. Preferred for the purposes of the invention is pyrogenic silicic acid in an amount of 0.5 to 1.5 weight %. The thixotropic agent forms Van-der-Waals compounds with the resin or resin components, which brings about a lowering of the viscosity under application of mechanical forces during the pre-processing. After cessation of the mechanical load there results a return of the thixotropism, whereby a run-off from vertical surfaces is prevented.

Further components of the coating composition are photo initiators, which are present in an amount of 0.01 to 10 weight %, preferably 1 to 3 weight %. These are compounds, which form starting radicals or radical initiators upon influence of energizing radiation, and which initiate the polymerization of the coating layer. Suitable UV-initiators in the framework of the present invention include for example benzoin ether, benzyldimethylketal, diethoxyacetophenone, hydroxyketone, aminoketone, benzophenone, a mixture of benzophenone and 1-hydroxy-cyclohexyl-phenylketone (trade name Irgacure® of Ciba Specialty Chemicals, Basel), 2-hydroxy-2-methyl-1-phenyl-propan-1-one (trade name Darocur® of Ciba Specialty Chemicals, Basel), monoacylphosphinoxide and bisacylphosphinoxide, or mixtures thereof (trade name Lucirin® of BASF).

Conventional additives are added to the coating composition. These include for example additives for increasing the strength, thermal resistance and light resistance. They can be selectively added in amounts of approximately 0 to 20 weight %. For controlling the surface tension of the coating material and for adjusting for good application characteristics, surface active substances are added in concentrations of 0.0001 to 2 weight %, preferably organic silicone compounds of polymethylsiloxane type (trade name Baysilone® of Bayer).

Further suitable additives include stabilizers or inhibitors, which inhibit potential radical initiators. The employed amount lies in the order of approximately 0 to 20 weight %, preferably 0 to 8 weight %. Stabilizers or inhibitors employable in the framework of the invention could be hydroquinone, hydroquinone-monomethylether, p-benzoquinone, p-teriary-butylcatechol, phenothiazine, 2,6-di-tertiary-butylhydroxytoluol, steric hindered amines and benzotrizol (trade name Tinuvin® of Ciba Specialty Chemicals, Basel).

The coating composition of the present invention is a material which has no pot life in a sense of a short life. It is actuated by the influence of UV-radiation and is caused to polymerize by UV-initiators. This has the consequence, that sprayed material, which lands for example on a conveyor belt, is recyclable and, by appropriate equipment, can be returned or recycled. Owing to the use of functional reactive diluents instead of organic solvents, there results during the polymerization process no reduction in weight. This has the result, that the recycled materials can be returned without great complexity, and on the other hand, that the hardened acrylate coating remains form-stable and later gives off no volatile products. The later is an essential precondition for a low VOC-value. The functionality of the reactive diluent and therewith its polymerizability is an important selection criteria during the use thereof, in addition to the viscosity, the diluting effect and the volatility. If stabilizers used during production remain in the product, then the coating characteristics cannot be advantageously influenced thereby. In all cases UV-initiators are emitted out of the product, of which the cleavage products are however emitted from the coating only after achieving a temperature of above 100° C.

For preventing the emission of volatile components the reaction conditions inclusive of temperature, mixing etc. as well as stabilizers and UV-initiator system must be carefully coordinated relative to each other. A temperature of the reaction system of approximately 110 to 130° C. should not be exceeded.

The use of functional reactive diluents is an essential precondition for low values of volatile organic compounds (VOC).

### ILLUSTRATIVE EXAMPLES

### Example 1

A coating composition is prepared, in which the following components are mixed with each other simply with heating (to approximately 40° C.) in order to bring about a solution of these components. The formulation has a viscosity of approximately 550 mPa (measured at 21° C.).

60 parts by weight epoxy diacrylate, molecular weight: 2,500;

20 parts by weight reactive diluent 1,6-hexane diol-diacrylate

1 part by weight pyrogenic silcic acid;

2 parts by weight UV-initiator comprised of a mixture of monoacryl-phosphine oxide and bisacylphosphineoxide;

0.1 part by weight polymethylsiloxane;

1 part by weight benzotriazol.

### Example 2

The components of Example 1 were employed, with the exception, that in place of the reactive diluent a mixture of 20 parts by weight hexane diol-diacrylate and 15 parts by weight tri-propylene glycol diacrylate were employed. In place of the UV-initiators, one part by weight of mixture of benzophenone and 1-hydroxy-cyclohexyl-phenylketone were employed. The coating formulation was prepared as indicated in Example 1. The formulation had a viscosity of approximately 600 mPa.s (measured at 21° C.).

### Example 3

The components of Example 1 were employed, with the exception, that in place of the reactive diluent 35 parts by weight of a mixture of hydroxy-methyl-ethyl-acrylate and hydroxy-propylacrylate were employed. The UV-initiator is 2-hydroxy-2-methyl-1-phenylpropan-1-one (Darocur®).

The coating formulation was prepared as indicated in Example 1. The formulation had a viscosity of approximately 580 mPa.s (measured at 21° C.).

### Example 4

The components of Example 1 were employed, with the exception, that in place of the reactive diluent 20 parts by weight polyester acrylate (Laromer®), MW: 2,100 were employed.

Suitable application processes for the inventive coating composition, besides spraying, also included pouring, flooding, dipping and roller coating. Inventively preferred is a hot spraying process with a coating material temperature of 35 to 60° C. The total number of coating applications was 4 to 8 applications. Per application 50 to 500 g/m², preferably 150 to 250 g/m² were sprayed on.

After the application of the coating film on the substrate there occurred polymerization by means of UV-radiation. This could advantageously also be carried out under an inert atmosphere, for example under nitrogen atmosphere, in order to exclude polymerization inhibitors in ambient oxygen. Since different additives could be considered hazardous materials, for example, may present a risk following contact with skin, it is advantageous to carry out the application of the coating materials in an enclosed space.

The duration of the UV-radiation exposure necessary for setting and/or hardening depends upon the temperature and the chemical composition of the coating composition, the type and output of the UV-source, the distance thereof from the coating material and the presence of an inert atmosphere. General values for the duration of coating range from a few seconds to a few minutes. The UV-radiation source should emit radiation at a wavelength the area of approximately 150 to 600 nm, preferably 200 to 400 nm. The radiated energy lies in the range of approximately 5 to 2,000 mJ/cm². General values for the distance of the UV-source to the coating layer lie in the range of approximately 20 to 1,000 mm.

The above-described coating materials are employed in a coating process as described below.

As substrate, an interior precious wood veneer for automobiles was selected.

The wood was puttied or mordanted with a spatula and hardener, and hardened approximately 2 hours at 20 to 28° C. at 50 to 60% relative humidity.

After a grinding finishing of the wood, a hydrogen peroxide (35 weight %) with bleach additive was sprayed on the wood substrate for bleaching. Drying was carried out for 48 hours with the conditions indicated for the puttying.

The wood substrate was subsequently stained by spraying on of a dye solution and dried 4 hours under the conditions indicated above for the puttying and again cooled to room temperature.

For priming, a two component polyurethane system was sprayed on. The application amount was 20 to 40 g/m², depending upon the part and type of wood, with 1 or 2 applications and airing out between the applications.

Hardening: 3 to 16 hours at 20 to 23° C. at 50 to 60% relative humidity.

For insulating, a colorless insulating base (two component polyurethane system) and hardener was sprayed with an application amount of 20 to 40 g/m². Hardening: 3 to 16 hours at 20 to 23° C. at 50 to 60% relative humidity.

For coating, one of the above-described coating systems was applied by warm spraying. The coating temperature was 35 to 60° C. The application amount: 4 to 8×150 to 180 g/m². After airing-out, polymerization was carried out using UV-radiation. For this, cold light—that is—two emitters of different wavelength and output, were employed. Duration: 1 to 2 minutes at 20 to 35° C. with 5 W/cm light output. Setting, hardening: V=1.5 to 3 m/Min. with 80 W/cm light output.

The follow-up hardening was carried out for 16 hours at 50° C.

VOC-determination occurred according to existing standards using two processes:

1. Head Space Method (GC-MS=gas chromatographic-mass spectroscopy) and

2. TDS-GC-Method (thermal desorption-gas chromatography).

Both processes were carried out at elevated temperatures, the TDS-GC-process in the range of from 90 to 120° C., for example at 120° C. The total material was subjected to this temperature. What evaporated thereby was considered to be VOC.

With the Head Space GC-MS there were measured up to 90° C., with the so-called polyester high gloss coating systems, VOC-values of approximately 1,500 ppm, and with paraffin containing polyester coatings VOC-values of approximately 1,700 to 2,200 ppm. In contrast thereto, there were measured with the present inventive illustrative embodiment VOC-values of approximately 40 to 60 ppm.

In summary the following can be concluded:

The invention relates to acrylate-based coating compositions which can be hardened by means of UV radiation, and used to coat wood components. Said coating compositions contain 5 to 80 weight % of acrylic resin, 5 to 75 weight % of a reactive diluent, 0.1 to 5 weight % of a thixotropic agent, 0.1 to 10 weight % of a photo-initiator and 0.05 to 20 weight % of an additive. The invention also relates to a method for producing coatings, wherein 4 to 8 layers are hot-sprayed onto prefabricated wooden elements and hardened by means of UV radiation.

The invention is characterized in that the coated components have low emissions after the final hardening and have VOC values (volatile organic compounds) of <100 ppm. Said values are far below the standard values of known polyester lacquers.

1. Flowable coating composition curable by UV-radiation, comprising the following components:
5 to 80 weight % of a mixture of monomers, oligomers and polymers of multifunctional polymerizable acrylates and/or methacrylates;
5 to 75 weight % of a reactive diluent;
0.1 to 5 weight % of a thixotropic agent;
0.1 to 10 weight % of a photo-initiator and
0.05 to 20 weight % of additive.

2. Coating composition according to claim 1, comprising the following components:
20 to 80 weight % of a mixture of monomers, oligomers and polymers of multifunctional, polymerizable acrylates and/or methacrylates;
5 to 25 weight % of a reactive diluent;
2 to 4 weight % of a thixotropic agent;
2 to 5 weight % of a photo-initiator and
0.05 to 10 weight % of additive.

3. Coating composition according to claim 1 or 2, thereby characterized, that the multifunctional acrylates are selected from the group consisting of polyether-, polyester-, epoxy-, urethane-, melamine-, and silicon-acrylate and/or acrylated polyacrylates; polyether, polyester, epoxide, urethane, melamine, silicon methacrylate and/or methacrylated polyacrylates.

4. Coating composition according to one of claims 1 through 3, thereby characterized, that the multifunctional acrylate and/or methacrylate has a molecular weight in the range of 500 to 6,000,

5. Coating composition according to one of claims 1 through 4, thereby characterized, that the reactive diluents contain polymerizable residues and are selected from the group of acrylic esters of simple alcohols, hexane diol-diacrylate, hydroxymethyl ethyl acrylate, hydroxypropyl acrylate, polyethyleneglycol diacrylate, tri-methyl propane tri-acrylate, dipropylene glycol diacrylate, tri-propylene glycol diacrylate or mixtures thereof and polyester acrylates.

6. Coating composition according to one of claims 1 through 5, thereby characterized, that the reactive diluents have a molecular weight in the range of 50 to 500.

7. Coating composition according to one of claims 1 through 6, thereby characterized, that a thixotropic agent is incorporated, preferably one based on SiO₂.

8. Coating composition according to one of claims 1 through 7, thereby characterized, that the photo-initiator is a UV-initiator and is selected from the group consisting of benzoinether, benzyldimethylketal, diethoxyacetophenone, hydroxyketones, aminoketones, benzophenones, a mixture of benzophenones and 1-hydroxy-cyclohexyl-phenylketone, 2-hydroxy-2-methyl-1-phenyl-propan-1-one, monoacylphosphinoxide and bisacylphosphinoxide, or mixtures thereof.

9. Coating composition according to one of claims 1 through 8, thereby characterized, that as an additive a surface active agent, preferably an organic silicon compound of the polymethylsiloxane type, is included in a proportion of less than 2 weight %.

10. Coating composition according to one of claims 1 through 9, thereby characterized, that as additive at least one stabilizer and/or inhibitor is included, which is selected from the group consisting of hydroquinone, hydroquinon-monomethylether, p-benzoquinone, p-tertiary-butylcatechol, phenothiazine, 2,6-di-tertiary-butylhydroxytoluol, steric hindered amines and benzotriazol in a proportion of less than 8 weight %.

11. Coating composition according to one of claims 1 through 10, thereby characterized, that the components are so selected in their proportions based on weight, that a working viscosity of 150 to 250 mPa.s at 35 to 60° C. results.

12. Process for producing a coating on a pre-fabricated wood surface, thereby characterized, that a coating agent according to one of claims 1 through 11 is applied in multiple layers on the wood surface with a layer thickness of 50 to 500 μm by hot spraying at 35 to 80° C. and that each layer is set, following application, by UV-radiation.

13. Process according to claim 12, thereby characterized, that each layer is sprayed on with a layer thickness of 150 to 250 μm.

14. Process according to claim 12 or 13, thereby characterized, that the coating composition during spraying-on exhibits a viscosity of 150 to 250 mPa.

15. Process according to one of claims 12 through 14, thereby characterized, that for the setting of the layers a photo radiation in the wavelength range of 150 to 600 nm is employed.

16. Process according to one of claims 12 through 15, thereby characterized, that the setting of each layer is carried out on three-dimensional wood parts in an inert gas atmosphere.

17. Process according to one of claims 12 through 16, thereby characterized, that following the spraying-on and the setting of all layers, a follow-up hardening is carried out with UV-radiation.

18. Process according to one of claims 12 through 17, thereby characterized, that a total of 4 to 8 layers are sprayed on.

19. Process according to one of claims 12 through 18, thereby characterized, that the spraying-on and setting of the layers is carried out in an enclosed space.

20. Use of a coating composition produced in accordance with one of claims 1 through 11 for coating a wood component, which is intended for the interior of an automobile.
